(19) United States
(12) Patent Application Publication
(10) Pub. No.: US 2009/0117760 A1
(43) Pub. Date: May 7, 2009

(54) TERMINAL CONNECTING STRUCTURE

(75) Inventor: Kenji TAKAHASHI, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/257,503

(22) Filed: Oct. 24, 2008

(30) Foreign Application Priority Data
Nov. 1, 2007 (JP) 2007-285037

(51) Int. Cl. H01R 12/00

(52) U.S. Cl. 439/79

(57) ABSTRACT

A terminal connecting structure includes a connector housing which has a connector terminal and a retaining member, and a board which has a board terminal and a terminal insertion hole for receiving the connector terminal projected toward the board. The retaining member of the connector housing retains the board at a provisionally-retaining position and a completely-retaining position. A retaining position of the connector housing with respect to the board is changed between the provisionally-retaining position and the completely-retaining position when the connector housing is slid with respect to the board in a first direction. The terminal insertion hole is configured so that the connector terminal is movable in the terminal insertion hole along the first direction when the retaining position is changed between the provisionally-retaining position and the completely-retaining position. The connector terminal is connected to the board terminal in the completely-retaining position.

### BACKGROUND

This invention relates to a terminal connecting structure for connecting connector terminals of a connector to board terminals of a board.

One conventional terminal connecting structure of this type is disclosed in Patent Literature 1 mentioned below. This conventional terminal connecting structure is designed to connect a connection terminal of an electronic component to a component-side connection terminal of a bus bar. A distal end portion of the component-side connection terminal has a joint portion, and this joint portion has a joint surface which is to be jointed to the connection terminal of the electronic component. The joint portion extends a predetermined length from the distal end of the component-side connection terminal. Opposite side portions of that surface of the joint portion facing away from the joint surface are retracted toward the center of the distal end portion. The component-side connection portion and the connection portion of the electronic component are held against each other at their distal end portions in parallel relation, and in this condition a laser beam is applied to a generally central position of the distal end faces, so that the distal ends of the two connection terminals are fused to be integrally joined together.

[Patent Literature 1] JP-A-2006-302543

In the conventional connecting structure, the distal end of the connection terminal and the distal end of the component-side connection terminal are fused to be joined together by a laser beam. Therefore, once the two connection terminals were connected together, it was not easy to remove the electronic component from the bus bar by canceling the connection between the two connection terminals.

### SUMMARY

This invention has been made in view of the above circumstances, and an object of the invention is to provide a terminal connecting structure in which a connector can be easily attached to and detached from a board.

The above object has been achieved by a terminal connecting structure, comprising:

a connector housing which has a connector terminal and a retaining member; and

a board which has a board terminal and a terminal insertion hole for receiving the connector terminal projected toward the board,

wherein the retaining member of the connector housing retains the board at a provisionally-retaining position and a completely-retaining position, a retaining position of the connector housing with respect to the board being changed between the provisionally-retaining position and the completely-retaining position when the connector housing is slid with respect to the board in a first direction;

wherein the terminal insertion hole is configured so that the connector terminal is movable in the terminal insertion hole along the first direction when the retaining position is changed between the provisionally-retaining position and the completely-retaining position; and

wherein the connector terminal is connected to the board terminal in the completely-retaining position.

Preferably, the terminal insertion hole has a groove which extends in the first direction. The board terminal has a pair of side terminal parts arranged at both sides of the terminal insertion hole in a second direction perpendicular to the first direction and a connecting parts which connects the pair of the side terminal parts.

In the present invention, the connector can be removed from the board by canceling the retaining engagement of lock arms of the retaining member, and therefore there can be provided the terminal connecting structure in which the connector can be detachably mounted on the board.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing one preferred embodiment of a connector of the present invention and a bus bar board (to which the connector is to be connected) from the upper side;

FIGS. 2A and 2B are views explanatory of details of the construction of the bus bar board, and FIG. 2A is an enlarged plan view of a portion of the bus bar board, and FIG. 2B is a cross-sectional view taken along the line A-A of FIG. 2A;

FIG. 3 is a perspective views explanatory of a procedure of mounting the connector on the bus bar board, showing a condition before lock arms are inserted into respective insertion holes;

FIG. 4 a perspective views explanatory of the procedure of mounting the connector on the bus bar board, showing a condition in which the lock arms are inserted in the respective insertion holes; and

FIG. 5 a perspective views explanatory of the procedure of mounting the connector on the bus bar board, showing a condition in which the lock arms are moved into respective fixing holes.

### DETAILED DESCRIPTION OF EXEMPLARY EMBODIMENTS

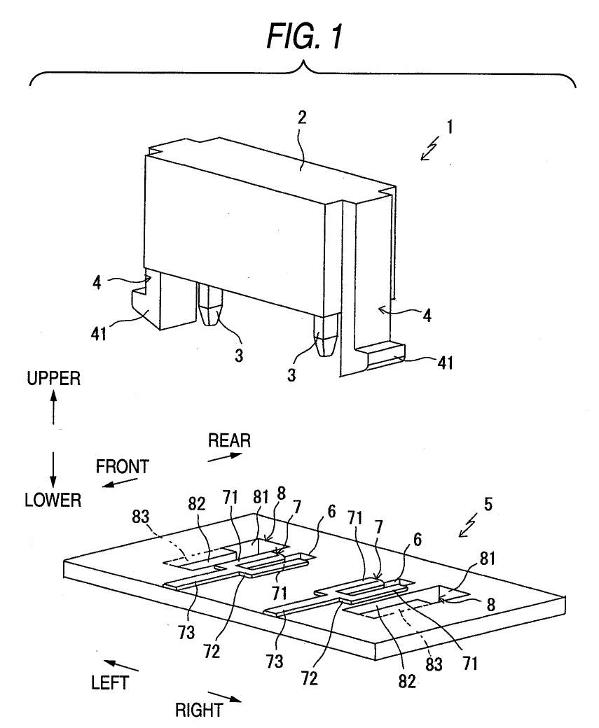

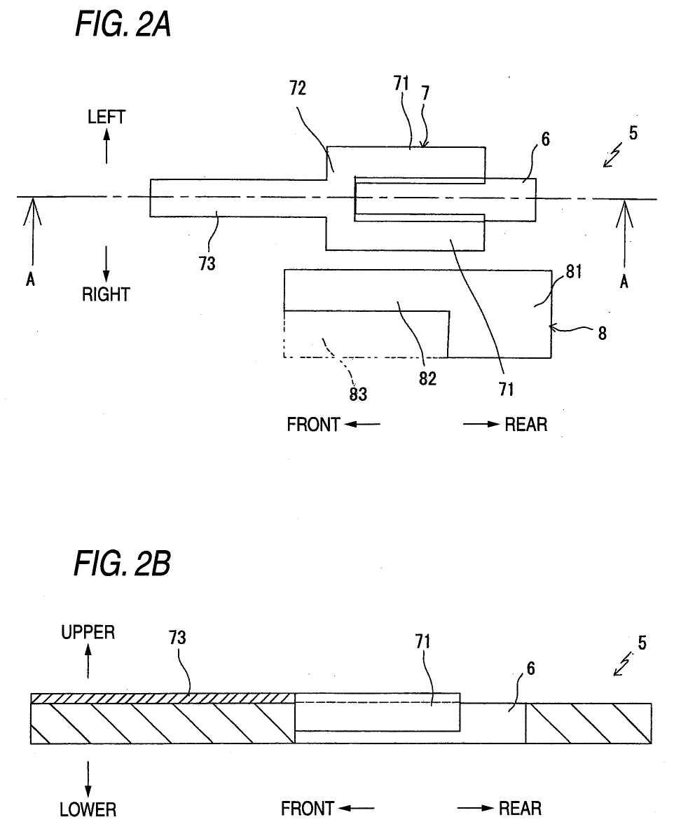

A preferred embodiment of the present invention will now be described with reference to the drawings. FIG. 1 is a perspective view showing a connector 1 of this embodiment and a bus bar board 5 (to which the connector 1 is to be connected) from the upper side. FIGS. 2A and 2B are views explanatory of details of the construction of the bus bar board 5, and FIG. 2A is an enlarged plan view of a right side portion of the bus bar board 5, and FIG. 2B is a cross-sectional view taken along the line A-A of FIG. 2A. The upper, lower, front, rear, right and left sides used in the following description are defined on the basis of the accompanying drawings, and these are defined merely for description purposes, and may, of course, be different from those of an actual terminal connecting structure of the invention.

As shown in FIG. 1, the connector 1 comprises a housing 2 of a generally square box-shape, a plurality of (two in this embodiment) connector terminals 3 extending outwardly from the housing 2, and a pair of lock arms 4 for fixing the housing 2 to the bus bar board 5. The connector terminals 3 are received in a cavity formed within the housing 2, and have their respective distal end portions (connecting portions) exposed to the exterior of the housing 2.

The two lock arms 4 each having a generally rectangular block-shape are formed respectively at opposite (right and left) side faces of the housing 2, and extend downwardly. Each lock arm 4 has a retaining portion 41 formed on and projecting from an (right or left) outer surface of its lower end portion. The retaining portion 41 is formed on the outer surface of the lock arm 4 over an entire width thereof in the forward-rearward direction, that is, extends between front and rear edges of the outer surface of the lock arm 4. This retaining portion 41 has a generally rectangular block-shape. An upper surface of the retaining portion 41 extends generally parallel to a lower surface of the housing 2, and a lower surface of the retaining portion 41 is slanting upwardly from its inner edge to its outer edge. A lower surface of the lock arm 4 is continuous with the lower surface of the retaining portion 41, and is slanting upwardly from its inner edge to its outer edge at the same angle as that of the lower surface of the retaining portion 41.

As shown in FIG. 1, the bus bar board 5 (to which the connector 1 is to be connected) includes a pair of terminal insertion holes 6 for respectively receiving the connector terminals 3, board terminals 7 for connection respectively to the connector terminals 3 inserted in the respective terminal insertion holes 6, and a pair of retaining holes 8 for respectively receiving the lock arms 4 of the connector 1.

As shown on an enlarged scale in FIG. 2, the terminal insertion hole 6 extends through the bus bar board 5 from an upper surface thereof to a lower surface thereof, and has a generally rectangular shape when viewed from the upper side. The board terminal 7 includes a pair of connection portions 71 for holding the connector terminal 3 therebetween to be connected thereto, and an interconnecting portion 72 interconnecting the two connection portions 71. Each board terminal 7, together with a wiring 73, is formed on the bus bar board 5 by printing.

The pair of connection portions 71 (each having a generally rectangular shape when viewed from the upper side) are formed respectively on opposite (right and left) side portions of the terminal insertion hole 6. Each connection portion 71 covers an area extending upwardly from a generally central portion (in the direction of the height) of an inner side surface of the terminal insertion hole 6 to the upper surface of the bus bar board 5, and also extends to the front end of the terminal insertion hole 6 from that portion of a rear end portion of the terminal insertion hole 6 which is spaced from the rear end thereof. A rear edge of each connection portion 71 is so disposed that the connection portion 71 will not contact the connector terminal 3 when each lock arm 4 of the connector 1 is inserted into an insertion hole 81 (described later) of the retaining hole 8 and that the connection portion 71 can contact the connector terminal 3 when each lock arm 4 is moved from the insertion hole 81 into a fixing hole 82. Each connection portion 71 has a corner portion formed on a corner portion defined by the side surface of the terminal insertion hole 6 and the upper surface of the bus bar board 5, and the opposed corner portions of the pair of connection portions 71 of the board terminal 7 are defined respectively by inclined (or tapering) surfaces facing each other generally upwardly. The interconnecting portion 72 is formed on the upper surface of the bus bar board 5, and is disposed at the front side of the terminal insertion hole 6, and is connected to front ends of the two connection portions 71. The interconnecting portion 72 has a rectangular shape when viewed from the upper side, and covers the relevant portion of the upper surface of the bus bar board 5, and the wiring 73 is connected to a central portion (in the right-left direction) of the interconnecting portion 72.

As shown in FIG. 2, the retaining hole 8 includes the insertion hole 81 for the insertion of the lock arm 4 thereinto, and the fixing hole 82 extending forwardly from a front edge of the insertion hole 81. The insertion hole 81 has a generally rectangular shape, and is slightly larger than a transverse cross-sectional area of the lower end portion of the lock arm 4. As shown in FIG. 1, the fixing hole 82 disposed at the left side portion of the bus bar board 5 extends forwardly from a right side portion of the front edge of the insertion hole 81. Also, the fixing hole 82 disposed at the right side portion of the bus bar board 5 extends forwardly from a left side portion the front edge of the insertion hole 81. Each fixing hole 82 has a width (in the right-left direction) generally equal to a transverse cross-sectional area of that portion of the lock arm 4 extending upwardly from the retaining portion 41. The bus bar board 5 has two retaining piece portions 83 disposed respectively at the sides of the right and left retaining holes 8, and more specifically that portion of the bus bar board 5 which extends forwardly from the front edge of each insertion hole 81 along the fixing hole 82 defines the retaining piece portion 83 as shown on an enlarged scale in FIG. 2. When the retaining portion 41 of each lock arm 4 is moved from the insertion hole 81 into a retaining position, a lower surface of the retaining piece portion 83 is retainingly engaged with the upper surface of the retaining portion 41, thereby fixing the connector 1 to the bus bar board 5.

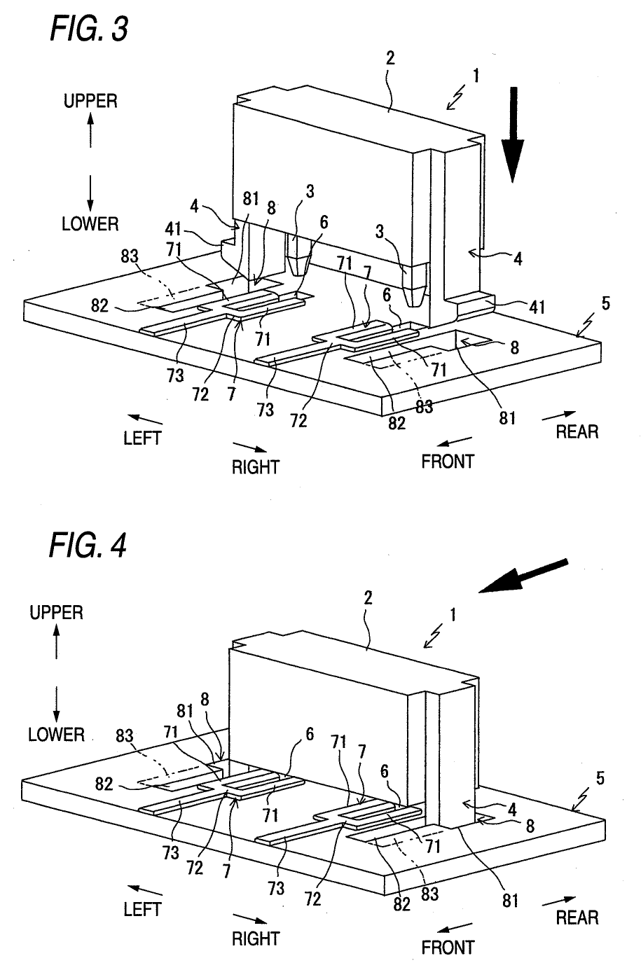

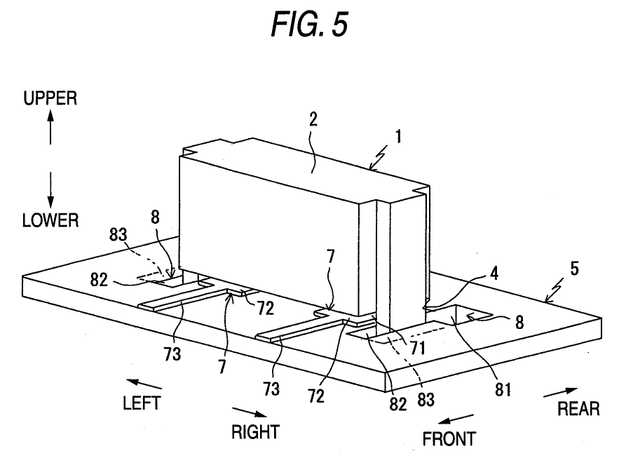

Next, description will be made of an operation in which the connector 1 is mounted on the bus bar 5, thereby connecting the connector terminals 3 to the respective board terminals 7. FIGS. 3 to 5 are perspective views showing the procedure of mounting the connector 1 on the bus bar board 5. FIG. 3 shows a condition before the lock arms 4 are inserted into the respective insertion holes 81, and FIG. 4 shows a condition in which the lock arms 4 are inserted in the respective insertion holes 81, and FIG. 5 shows a condition in which the lock arms 4 are moved into the respective fixing holes 82.

For mounting the connector 1 on the bus bar board 5, first, the lock arms 4 of the connector 1 are located respectively above the insertion holes 81 of the retaining holes 8 in the bus bar board 5 as shown in FIG. 3, and the lock arms 4 are inserted respectively into the insertion holes 81 as indicated by an arrow in FIG. 3. As a result, the retaining portion 41 (see FIG. 3) of each lock arm 4 is inserted into the insertion hole 81 from the upper side of the bus bar board 5, and projects downwardly from the lower surface of the bus bar board 5. In accordance with this inserting operation, the connector terminals 3 (see FIG. 3) projecting downwardly from the lower surface of the connector 1 are inserted respectively into the terminal insertion holes 6 from the upper side of the bus bar board 5. Thus, the connector 1 is provisionally retained on the bus bar board 5.

Then, when the connector 1 located in the provisionally-retaining position (see FIG. 4) is moved toward the front side of the bus bar board 5 as indicated by an arrow in FIG. 4, each lock arm 4 of the connector 1 is moved from the insertion hole 81 into the fixing hole 82, so that the bus bar board 5 is held between (or gripped by) each retaining portion 41 and the housing 2 as shown in FIG. 5. On the other hand, each connector terminal 3 moves forward in and along the terminal insertion hole 6 in accordance with the movement of the connector 1, and when each lock arm 4 enters the fixing hole 82, opposite (right and left) side faces of each connector terminal 3 are brought into contact respectively with those portions of the pair of connection portions 71 of the board terminal 7 formed respectively on the opposed inner side surfaces of the terminal insertion hole 6. Thereafter, each connector terminal 3 moves in and along the terminal insertion hole 6, with its opposite (right and left) side faces held in sliding contact respectively with the pair of connection portions 71.

Then, when the connector 1 is moved toward the front side of the bus bar board 5 until the front face of each lock arm 4 is brought into abutting engagement with a front surface of the fixing hole 82 of the retaining hole 8, the front face of each connector terminal 3 abuts against a front surface of the terminal insertion hole 6, thus finishing the operation for mounting the connector 1. When the connector 1 is thus mounted on the bus bar board 5, and is located in the completely-retaining position, the upper surface of the retaining portion 41 of each lock arm 4 is retainingly engaged with the lower surface of the retaining piece portion 83, so that the bur bar board 5 is held between the upper surface of each retaining portion 41 and the lower surface of the housing 2. Also, the front face and right and left side faces of each lock arm 4 are supported respectively by the front and right and left surfaces of the fixing hole 82. Furthermore, the front and right and left faces of each connector terminal 3 are held in contact with the front and right and left surfaces of the terminal insertion hole 6, respectively. In this manner, the positioning of the connector 1 relative to the bus bar board 5 is thus effected, and also the connection of the connector terminals 3 to the respective board terminals 7 is effected. Incidentally, in so far as the connector terminals 3 are held in contact with the respective board terminals 7 when the connector 1 is located in the completely-retaining position, the front face of each lock arm 4 does not always need to abut against the front edge of the fixing hole 82, and also the front face of each connector terminal 3 does not always need to abut against the front edge of the terminal insertion hole 6.

In this embodiment, the lock arms 4 are inserted respectively into the insertion holes 81, and thereafter the connector 1 is moved forward so as to introduce the lock arms 4 into the respective fixing holes 82, and by doing so, the connector terminals 3 can be connected to the respective board terminals 7, and also the retaining portions 41 can be retainingly engaged with the respective retaining piece portions 83, thereby fixing the connector 1 to the bus bar board 5. For removing the connector 1 from the bus bar board 5, the connector 1 fixed to the bus bar board 5 is moved rearward, thereby canceling the retaining engagement of each retaining portion 41 with the retaining piece portion 83, and thereafter the lock arms 4 are withdrawn respectively from the insertion holes 81, and by doing so, the connector 1 can be removed from the bus bar board 5. Therefore, the connector 1 can be easily attached to and detached from the bus bar board 5.

Furthermore, the bus bar board 5 is held between each retaining portion 41 retained in the fixing hole 82 and the lower surface of the connector 1, and therefore the connector 1 can be firmly fixed to the bus bar board 5. Therefore, the connector 1 is prevented from being displaced relative to the bus bar board 5 and also from being changed in posture, and this can prevent the contacted condition of each connector terminal 3 relative to the board terminal 7 from being changed. As a result, the reliability of the electrical connection between each connector terminal 3 and the board terminal 7 can be enhanced. Furthermore, the connector terminal 3 moves in and along the terminal insertion hole 6, with its right and left side faces held in sliding contact respectively with the pair of connection portions 71 of the board terminal 7, and therefore the connector terminal 3 can be positively contacted with the connection portions 71, and the reliability of the electrical contact between the connector terminal 3 and each connection portion 71 can be secured.

Furthermore, in the above embodiment, when each lock arm 4 of the connector 1 is moved from the insertion hole 81 into the fixing hole 82, each connector terminal 3 is brought into contact with the board terminal 7, and is connected thereto. Therefore, when the operation for mounting the connector 1 is finished in a condition in which each lock arm 4 is kept inserted in the insertion hole 81 and is not moved into the fixing hole 82, the two connector terminals 3 are not connected together. Therefore, there can be avoided such a situation in which the operation for mounting the connector 1 is finished in the condition in which each lock arm 4 is kept inserted in the insertion hole 81 and is not moved into the fixing hole 82. As a result, the reliability of the electrical connection between each connector terminal 3 and the board terminal 7 can be further enhanced.

In the above embodiment, each connection portion 71 of the board terminal 7 is formed on that portion of the inner side surface of the terminal insertion hole 6 lying between the generally central portion thereof (in the direction of the height) and the upper surface of the bus bar board 5 and also on that portion of the upper surface of the bus bar board 5 defining the side edge portion of the terminal insertion hole 6. However, the connection portion 71 may be formed on that portion of the inner side surface of the terminal insertion hole 6 lying between the lower edge thereof to the upper surface of the bus bar board 5 and also on that portion of the upper surface of the bus bar board 5 defining the side edge portion of the terminal insertion hole 6, or may be formed only on the inner side surface of the terminal insertion hole 6. Furthermore, the board terminal 7 does not need to be formed only at part of the peripheral edge of the terminal insertion hole 6, but may be formed, for example, over the entire periphery of the terminal insertion hole 6.

In the above embodiment, the connector 1 is connected to the bus bard board 5 from the upper side thereof. However, the structure may be formed such that the connector 1 is connected to the bus bar board from the lower side thereof. In this case, each connection portion 71 may be formed on the inner side surface of the terminal insertion hole 6 and also on those portions of the upper and lower surfaces of the bus bar board 5 at the side edge of the terminal insertion hole 6. Each retaining hole 8 does not always need to extend through the bus bar board 5 from the upper surface thereof to the lower surface thereof, and may be a recess formed in one of the two surfaces of the bus bar board 5. Also, each terminal insertion hole 6 does not always need to extend through the bus bar board 5 from the upper surface thereof to the lower surface thereof, may be a recess formed in one of the two surfaces of the bus bar board 5. In the case where each retaining hole 8 extends through the bus bar board 5 from the upper surface thereof to the lower surface thereof, channel-shaped grooves extending in the direction of extending of the bus bar board 5 may be formed respectively in the right and left inner surfaces of the fixing hole 82, and in this case, the retaining portion 41 of the lock arm 4 is received in these grooves.

The number of the terminal insertion holes 6 in the bus bar board 5, as well as the number of the board terminals 7, can be suitably changed in accordance with the number of the connector terminals 3 to be connected respectively to the board terminals 7. Also, the number of the retaining holes 8 can be suitably changed in accordance with the number of the lock arms 4 to be formed on the connector 1. Furthermore, the number of the lock arms 4 of the connector 1 can be suitably changed in accordance with the shapes of the connector 1 and bus bar board 5. Furthermore, the number and shape of the retaining portion 41 of the lock arm 4 may be suitably changed.

There may be provided a construction in which the retaining portion 41 is formed on the inner surface of the lock arm 4, and the fixing hole 82 disposed at the left side portion of the bus bar board 5 extends forwardly from the left side portion of the front edge of the left insertion hole 81, while the fixing hole 82 disposed at the right side portion of the bus bar board 5 extends forwardly from the right side portion of the front edge of the right insertion hole 81. In the above embodiment, although the bus bar board 5 is used as the board, the invention can be applied also to a structure for connecting connector terminals to board terminals on any other suitable board.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2007-285037 filed on Nov. 1, 2007, the contents of which are incorporated herein for reference.

What is claimed is:

1. A terminal connecting structure, comprising:
a connector housing which has a connector terminal and a retaining member; and
a board which has a board terminal and a terminal insertion hole for receiving the connector terminal projected toward the board,
wherein the retaining member of the connector housing retains the board at a provisionally-retaining position and a completely-retaining position, a retaining position of the connector housing with respect to the board being changed between the provisionally-retaining position and the completely-retaining position when the connector housing is slid with respect to the board in a first direction;
wherein the terminal insertion hole is configured so that the connector terminal is movable in the terminal insertion hole along the first direction when the retaining position is changed between the provisionally-retaining position and the completely-retaining position; and
wherein the connector terminal is connected to the board terminal in the completely-retaining position.

2. The terminal connecting structure according to claim 1, wherein the terminal insertion hole has a groove which extends in the first direction; and
wherein the board terminal has a pair of side terminal parts arranged at both sides of the terminal insertion hole in a second direction perpendicular to the first direction and a connecting parts which connects the pair of the side terminal parts.

3. The terminal connecting structure according to claim 1, wherein the connector terminal is connected to the board terminal when the retaining position is located at the completely-retaining position; and
wherein the connector terminal is not connected to the board terminal when the retaining position is located at the provisionally-retaining position.
